(19) United States
(12) Patent Application Publication
(10) Pub. No.: US 2017/0285813 A1
(43) Pub. Date: Oct. 5, 2017

(54) Touch-Input Support for an External Touch-Capable Display Device

(71) Applicant: Microsoft Technology Licensing, LLC, Redmond, WA (US)

(72) Inventors: Elizabeth Fay Threlkeld, Duvall, WA (US); William Scott Stauber, Seattle, WA (US); Kristina Rose Cosgrave, Kirkland, WA (US); Keri K. Moran, Redmond, WA (US); Issa Yousef Khoury, Redmond, WA (US); Petteri Jussinpoika Mikkola, Bellevue, WA (US); Giorgio Sega, Redmond, WA (US); Rouella J. Mendonca, Seattle, WA (US); Bruce Cordell Jones, Redmond, WA (US); Darren R. Davis, Woodinville, WA (US)

(73) Assignee: Microsoft Technology Licensing, LLC, Redmond, WA (US)

(21) Appl. No.: 15/160,899

(22) Filed: May 20, 2016

Related U.S. Application Data
(60) Provisional application No. 62/314,821, filed on Mar. 29, 2016.

(51) Int. Cl. G06F 3/041; G06F 3/0484

(52) U.S. Cl. CPC G06F 3/0412; G06F 3/0484

(57) ABSTRACT

Touch-input support for an external touch-capable display device is described. A computing device (e.g., a smartphone) is configured to form a connection with an external touch-capable display device that is separate from the computing device. The computing device controls the display of information on the touch-capable display device. A user of the computing device can interact with the external touch-capable display device, such as by touching the screen of the touch-capable display device to select items, perform gestures, or type on the on-screen keyboard. When the user provides touch-input to the external touch-capable display device, the computing device receives an indication of the touch-input via the wired or wireless connection. The computing device then modifies the display of information on the touch-capable display device based on the touch-input.

### PRIORITY

This application claims priority to U.S. Provisional Patent Application No. 62/314,821, filed Mar. 29, 2016, and titled “Touch-Input Support for an External Touch-Capable Display Device” the disclosure of which is incorporated by reference in its entirety.

### BACKGROUND

Users today often utilize two or more computing devices to perform different tasks. For example, a user may use a smartphone to place telephone calls and browse the internet, and use a desktop computer for work at the Office. However, with the increasing processing capabilities of mobile computing devices, such as smartphones, users increasingly want to eliminate some of their devices so that a single device can be used to power different experiences

### SUMMARY

Touch-input support for an external touch-capable display device is described. In various implementations, a computing device (e.g., a smartphone) is configured to form a connection with an external touch-capable display device that is separate from the computing device. The computing device controls the display of information on the touch-capable display device. A user of the computing device can interact with the external touch-capable display device, such as by touching the screen of the touch-capable display device to select items, perform gestures, or type on the on-screen keyboard. When the user provides touch-input to the external touch-capable display device, the computing device receives an indication of the touch-input via the wired or wireless connection. The computing device then modifies the display of information on the touch-capable display device based on the touch-input.

The described techniques allow a single mobile computing device, such as a smartphone, to control two or more different user experiences by enabling user interaction with the touch-capable external display that is coupled to the mobile computing device to be separate from user interaction with the mobile computing device, such as via an integrated display.

### BRIEF DESCRIPTION OF THE DRAWINGS

The detailed description is described with reference to the accompanying figures. The same numbers are used throughout the drawings to reference like features and components.

FIG. 1 illustrates an example system implementing touch-input support for an external touch-capable display device in accordance with one or more embodiments.

FIG. 2 illustrates an example computing device controlling an external touch-capable display device and an integrated display concurrently in accordance with one or more embodiments.

FIG. 3 depicts a procedure in an example implementation of controlling the display of information on an external touch-capable display device.

FIG. 4 depicts a procedure in an example implementation of controlling the display of information on an external touch-capable display device separately from the display of information on an integrated display.

FIG. 5 illustrates an example system that includes an example computing device that is representative of one or more systems and/or devices that may implement the various techniques described herein.

### DETAILED DESCRIPTION

### Overview

Touch-input support for an external touch-capable display device is described. A mobile computing device (e.g., a smartphone) is configured to form a connection with an external touch-capable display device that is separate from the mobile computing device (e.g., a touch-capable monitor or tablet display). The mobile computing device can establish the connection to the external touch-capable display device in a variety of different ways, such as wirelessly (e.g., wireless USB, Bluetooth, Miracast, etc.) or via a wired connection (e.g., universal serial bus (USB), DisplayPort, high-definition multimedia interface (HDMI), etc.).

Once the connection is established, the mobile computing device can detect that the external touch-capable display device is configured for touch-input, such as by detecting the presence of a digitizer. Then, the mobile computing device controls the display of information (e.g., a home screen, application user interfaces, and so forth) on the touch-capable display device. In some cases, the display of information includes presentation of an “on-screen keyboard” that enables the user to type by touching locations on the touchscreen of the touch-capable display device that correspond to keys of the keyboard. However, if it is determined that the external touch-capable display device is coupled to a hardware keyboard, that the mobile computing device may not display the on-screen keyboard based on an understanding that the user may prefer to use a hardware keyboard if one is available.

A user of the mobile computing device can interact with the external touch-capable display device, such as by touching the screen of the touch-capable display device to select items, perform gestures, or type on the on-screen keyboard. When the user provides touch-input to the external touch-capable display device, the mobile computing device receives an indication of the touch-input via the wired or wireless connection. The computing device then modifies the display of information on the touch-capable display device based on the touch-input.

In one or more implementations, the mobile computing device can display different information on an integrated display of the mobile computing device concurrently with the display of information on the touch-capable display device. Further, the display of information on the touch-capable display device can be modified based on the touch-input without modifying the display of the different information on the integrated display. In this way, the mobile computing device can power two different user experiences such that touch can be used to interact with the information (e.g., applications, content, and user interface) displayed on the external touch-capable display device without it affecting the state or input mechanics of the mobile computing device that is powering the external touch-capable display device. For example, the mobile computing device may display a home screen on the touch capable display that allows the user to perform various productivity-related tasks, and concurrently display a home screen on an integrated display that is part of the mobile computing device for the user to use the mobile computing device as a telephone.

Thus, the described techniques allow a single mobile computing device, such as a smartphone, to control two or more different user experiences by enabling user interaction with a touch-capable external display to be separate from user interaction with the mobile computing device, such as via the integrated display. Notably, this enables a single smartphone to be utilized as a phone while also powering a secondary experience, such as a desktop or tablet experience, on an external touch-capable display device. Doing so eliminates the need for the user to rely on two different devices, and instead a single device can be used for two or more different experiences (e.g., as a phone and a productivity tool) by simply connecting the mobile computing device to the external touch-capable display device. Furthermore, unlike conventional solutions, different information may be displayed on the external touch-capable display and the integrated display at the same time, instead of disabling the display of information on the integrated display while the external touch-capable display is active or mirroring the display of information on both display screens.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

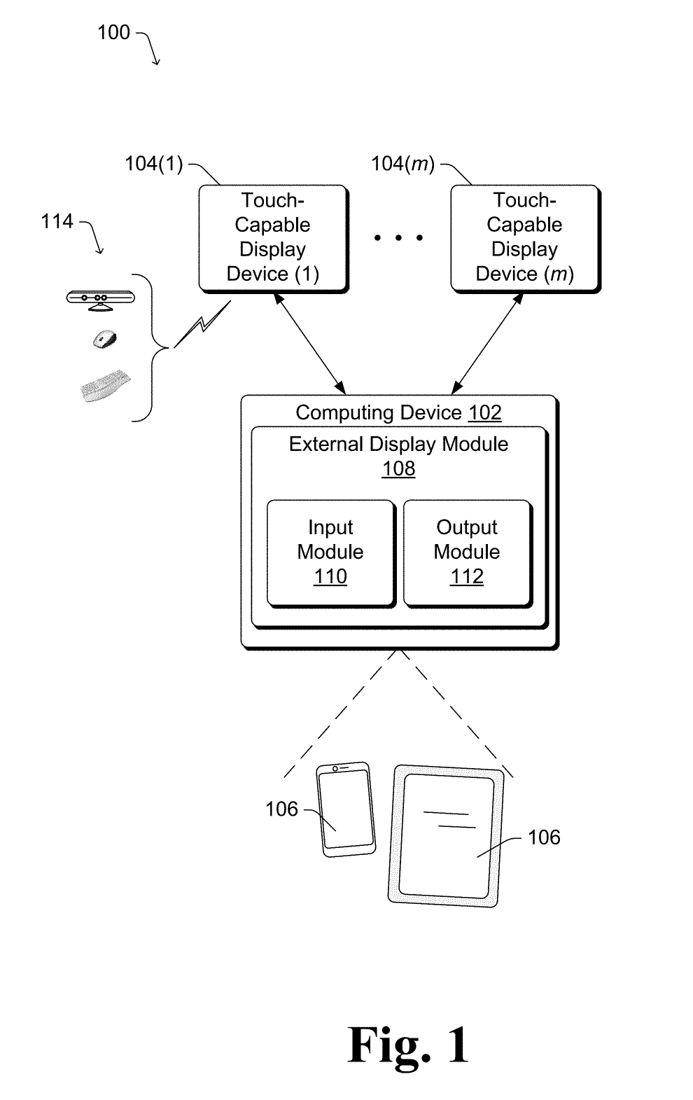

FIG. 1 illustrates an example system implementing touch-input support for an external touch-capable display device in accordance with one or more embodiments.

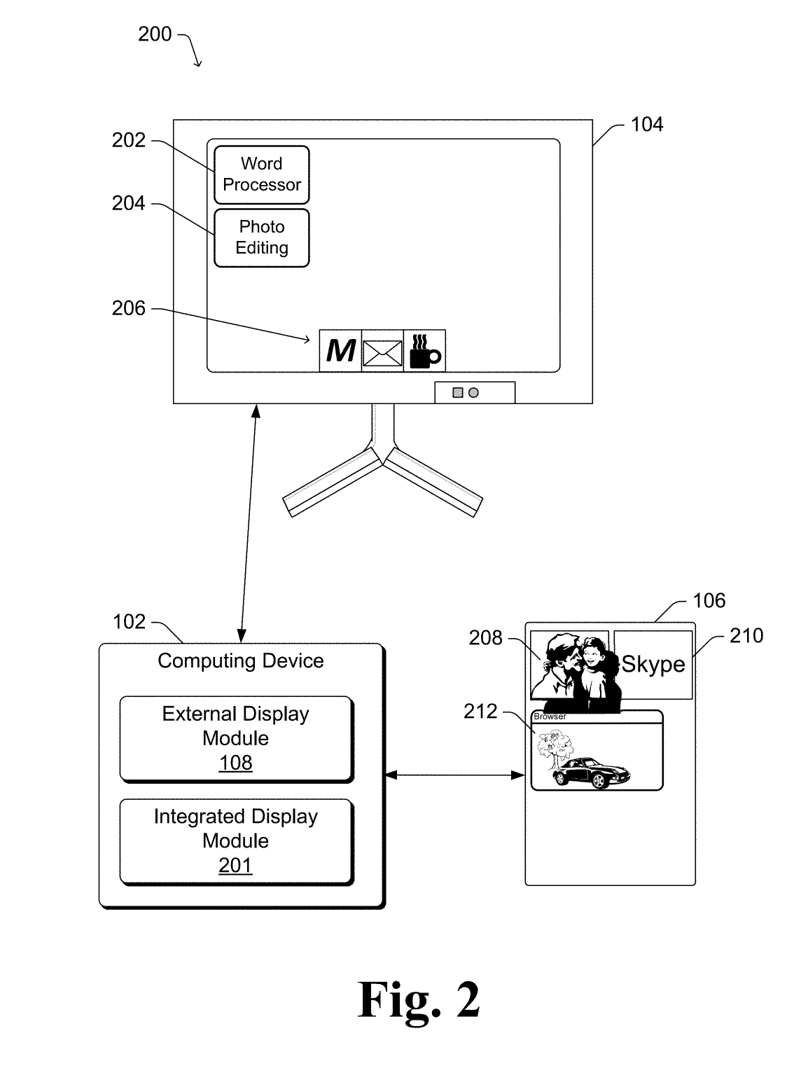

FIG. 2 illustrates an example computing device controlling an external display device and an integrated display concurrently in accordance with one or more embodiments.

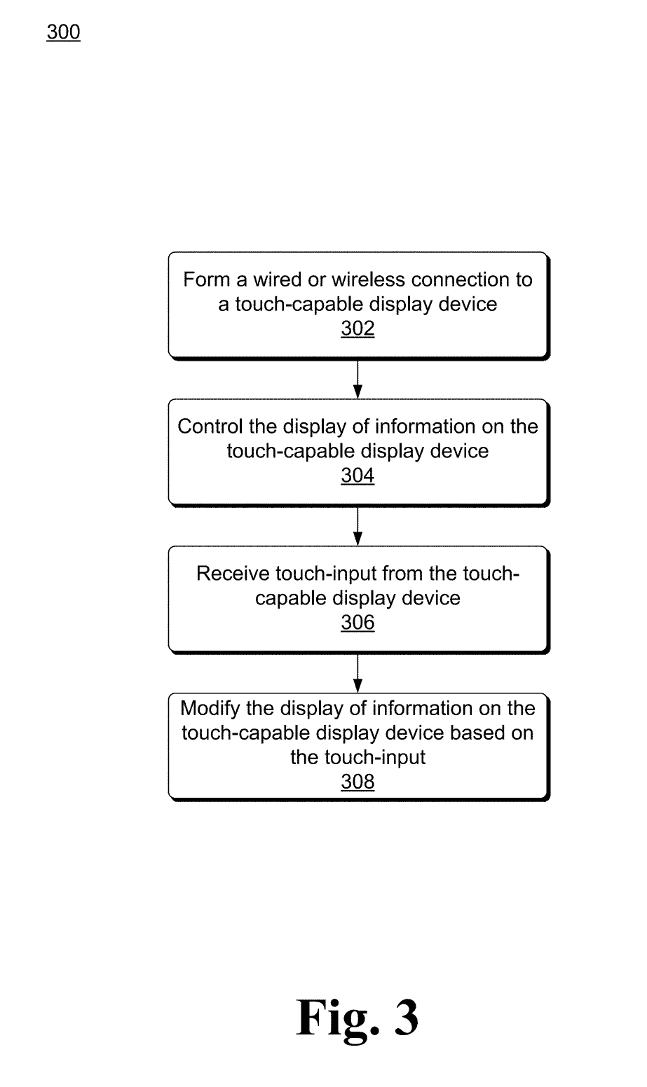

FIG. 3 depicts a procedure in an example implementation of controlling the display of information on an external touch-capable display device.

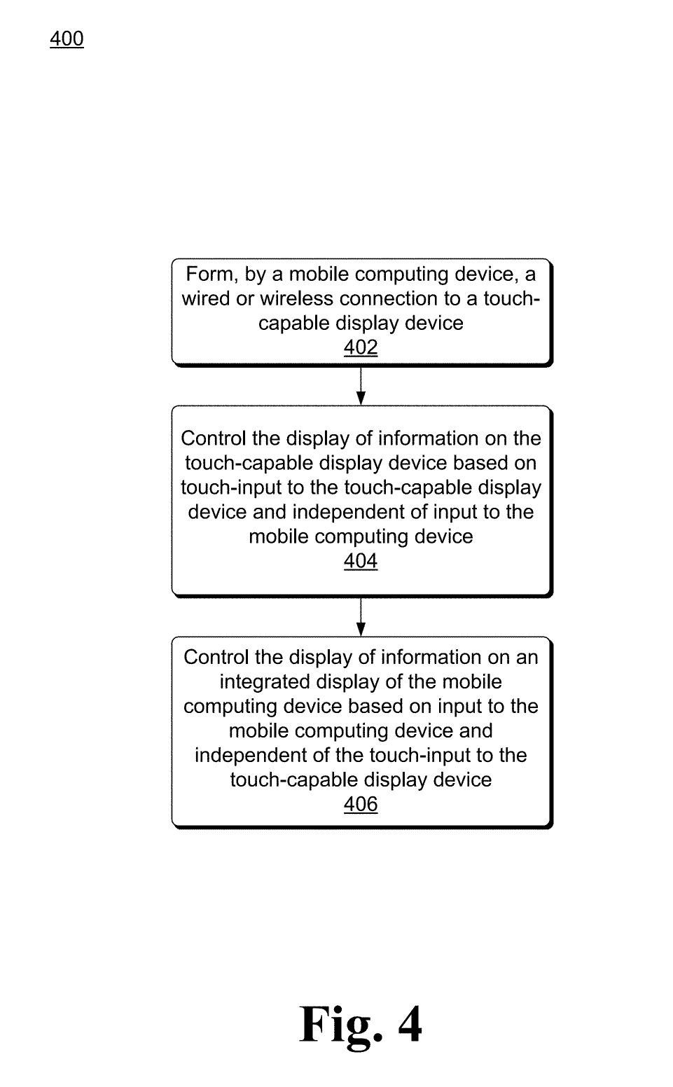

FIG. 4 illustrates an example system that includes an example computing device that is representative of one or more systems and/or devices that may implement the various techniques described herein.

### Example System

FIG. 1 illustrates an example system 100 implementing touch-input support for an external touch-capable display device in accordance with one or more embodiments. System 100 includes a mobile computing device 102 that can be communicatively coupled to one or more (m) external touch-capable display devices 104. The computing device 102 can be a variety of different types of devices, and typically is a mobile device such as a cellular or other wireless phone (e.g., a smartphone), a tablet or phablet device, a notepad computer, a laptop or netbook computer, a wearable device (e.g., eyeglasses, watch), and so forth. Alternatively, the computing device 102 can be other types of devices that are not typically considered to be mobile devices, such as an entertainment device (e.g., an entertainment appliance, a set-top box communicatively coupled to a display device, a game console), a desktop computer, a server computer, a television, and so forth.

The computing device 102 can be coupled to a touch-capable display device 104 in different manners using a network interface, including wired couplings (e.g., universal serial bus (USB), DisplayPort, high-definition multimedia interface (HDMI), etc.) and/or wireless couplings (e.g., wireless USB, Bluetooth, etc.). In one or more implementations, the computing device 102 may be coupled to touch-capable display device 104 via a wireless dock (e.g., miracast) that is connected to the touch-capable display device 104.

A touch-capable display device 104 includes a touchscreen that is configured to both display information and detect touch-input from a user, such as when the user touches the touchscreen to type on an on-screen keyboard, interact with controls of a user interface, or perform a gesture. Note that the method in which the touch-capable display device 104 determines touch may be any of the various embodiments known to exist, such as resistive, capacitive, or camera-based image processing technologies. Touch-capable display device 104 is external to the computing device 102 (in a housing separate from the computing device 102), such as a desktop monitor or living room television, an automotive display device, a tablet display device, and so forth. The touch-capable display devices 104 can be standalone display devices (e.g., display devices with little or no processing or other computing device capabilities, such as a desktop monitor) or can be included as part of other computing devices (e.g., a display device of an automotive PC, a display device of a tablet or laptop computer, a display device of a smart TV (e.g., that is capable of running various software programs), and so forth). Touch-capable display devices 104 may also be other general purpose computing devices with touch capability configured through software adaptations to expose capabilities such as display, mouse, keyboard, and touch to other computing devices 102 as if they were a standalone display device.

Computing device 102 may also include an integrated display 106 that is internal to the computing device 102 (in a same housing as the computing device 102), such as a smartphone display. In some cases, integrated display 106 may be a touch-capable display device.

The computing device 102 includes an external display module 108, which includes an input module 110 that is configured to receive touch-input from the touch-capable display device 104, and an output module 112 that controls the output (e.g., the display of information) to touch-capable display device 104 based on the touch-input. Although particular functionality is discussed herein with reference to system 108, it should be noted that the functionality of external display module 108 and individual ones of the modules 110 and 112 can be separated into multiple modules and/or systems, and/or at least some functionality of the external display module 108 and multiple modules 110 and 112 can be combined into a single module and/or system.

Generally, external display module 108 is configured to control the display of information from device 102 on touch-capable display device 104, and to modify the display of information based on touch-input to the touch-capable display device 104. When device 102 is first connected to touch-capable display device 104 (e.g., via a wired or wireless connection), external display module 108 determines the display 104 is configured to receive touch-input. For example, external display module 108 can determine that display 104 is touch-capable by detecting the presence of a digitizer. If the display 104 is determined to be touch-capable, the external display module 108 causes presentation of information (e.g., a home screen) from device 102 on touch-capable display device 104. The home screen may be specifically configured for touch-capable display device 104. For example, a first type of home screen (e.g., that includes an on-screen keyboard and touch-selectable controls) may be displayed if the display is touch capable, which may be different from a second type of home screen (e.g., that is configured for input via an external input device such as a mouse and/or keyboard) that is displayed if the display is not touch capable.

As described herein, a home screen, also referred to as a start screen, is the displayed screen from which the user can request to run various different programs of the computing device 102. In one or more embodiments, the home screen is the first screen with user-selectable representations of functionality displayed after the user logs into (or turns on or wakes up) the computing device 102. Various different user-selectable representations of functionality can be included on a home screen, such as tiles, icons, widgets, menus, menu items, and so forth, and these different representations can be selected via any of a variety of different user inputs. The functionality refers to different functions or operations that can be performed by the computing device, such as running one or more applications or programs, displaying or otherwise presenting particular content, and so forth. In one or more embodiments, the entirety of the home screen is displayed at the same time. Alternatively, different portions (also referred to as pages) of the home screen can be displayed at different times, and the user can navigate to these different portions using any of a variety of user inputs (e.g., left and right arrows, gestures such as swiping to the left or right, and so forth).

In one or more implementations, external display module 108 is implemented as a software stack that is independent of a second software stack that controls the user experience of the computing device 102. Thus, in some cases, the information displayed on the external touch-capable display device 104 is different than the information displayed on the integrated display 106 of the mobile computing device 102. This allows the user to use the different display devices independently. For example, the mobile computing device 102 may display a home screen on the touch-capable display device 104 which enables the user to perform various productivity-related tasks, and concurrently display a different home screen on the integrated display 106 to allow the user to use the mobile computing device 102 as a telephone.

Consider, for example, FIG. 2, which illustrates an example computing device 102 controlling an external touch-capable display device 104 and an integrated display 106 concurrently in accordance with one or more embodiments. FIG. 2 illustrates the computing device 102 as a smartphone that is coupled concurrently to a touch-capable display device 104 (e.g., a desktop monitor) and an integrated display (e.g., a smartphone display) of the computing device 102. In this example, computing device 102 is illustrated as including external display module 108, which can be implemented to control the display of information on the touch-capable display device 104. In addition, computing device 102 includes an integrated display module 201, which can be implemented to control the display of information on the integrated display 106 of computing device 102. The external display module 108 may be implemented as a software stack that is independent of a second software stack that is implemented by the integrated display module 201.

As illustrated in FIG. 2, a different home screen is displayed on each of the displays 104 and 106 by the computing device 102 concurrently. Touch-input to the touch-capable display device 104 selecting a representation 202, 204, or 206 is received by the computing device 102, and in response the computing device 102 controls the display of information on the touch-capable display device 104. Similarly, user input selecting a representation 208, 210, or 212 is received by the computing device 102, and in response the computing device 102 controls the display of different information on the integrated display 106. Thus, for example, the user can use the computing device 102 to make a Skype call (e.g., in response to user selection of the representation 210) while at the same time the user can begin editing a text document on the touch-capable display device 104 (e.g., in response to user selection of the representation 202).

Input module 110 is configured to receive user inputs from a user of the computing device 102 via user input (e.g., touch-input) to the touch capable display 104, such as by pressing one or more keys of an “on screen” keypad or keyboard displayed by touch-capable display device 104, pressing a particular portion of the touch-capable display device 104, or making a particular gesture on the touch-capable display device 104. Input module 110 may or may not function independently of a separate input module configured to manage user inputs received from a locally attached display and digitizer, such as a separate input module implemented by integrated display module 201.

The output module 112 generates, manages, and/or outputs information or content for display, playback, and/or other presentation. This information can be created by the output module 112 or obtained from other modules of the computing device 102. This information can be, for example, a display or playback portion of a user interface (UI), including a home screen. The information can be displayed or otherwise played back by components of the touch-capable display device 104 or other devices attached to the touch-capable display device 104 (e.g., external speakers). The output module 112 also modifies the display of information on the touch-capable display device 104 based on touch-input to the touch-capable display device 104 that is detected by input module 110. Output module 110 may or may not function independently of a separate output module configured to manage output to the integrated display 106, such as a separate output module implemented by integrated display module 201.

In one or more implementations, touch-capable display device 104 can be coupled to one or more peripheral devices 114, such as a hardware keyboard or keypad, a video camera, a mouse or other cursor control device, and so forth. Thus, via the connection to touch-capable display device 104, the computing device 102 can utilize the peripheral devices 114. By way of example, the peripheral device 114 can be connected to (e.g., wirelessly or wired) touch-capable display device 104 that is communicatively coupled to the computing device 102. By way of another example, the peripheral device 114 can be connected to (wirelessly or wired) an intermediary device (e.g., a docking station) to which touch-capable display device 104 and the computing device 102 are both communicatively coupled.

In one or more implementations, external display module 108 is configured to detect whether a hardware keyboard is coupled to touch-capable display device 104. If a hardware keyboard is not coupled to the touch-capable display device 104, then output module 112 may cause display of an “on-screen” keyboard on touch-capable display device 104 that enables the user to type by touching locations on the touch-capable display device 104 that correspond to keys of the on-screen keyboard. For example, if the touch-capable display device 104 comprises a tablet device, then the user may rely on the touchscreen for input, such as by typing on the touchscreen. However, if external display module 108 determines that the touch-capable display device 104 is coupled to a hardware keyboard, that the computing device 102 may not display the on-screen keyboard based on an understanding that the user may prefer to use the hardware keyboard for input.

The external display module 108 can be implemented in a variety of different manners. In one or more embodiments, the external display module 108 is implemented as part of an operating system running on the computing device 102. Alternatively, the external display module 108 is implemented partly in the operating system of the computing device 102 and partly as an application (e.g., a companion application) that runs on the operating system of the computing device 102. Alternatively, the external display module 108 is implemented as an application that runs on the operating system of the computing device 102, such as a launcher or container application that displays the home screen.

### Example Procedures

The following discussion describes techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks.

FIG. 3 depicts a procedure 300 in an example implementation of controlling the display of information on an external touch-capable display device.

At 302, a wired or wireless connection to a touch-capable display device is formed. For example, computing device 102, such as a smartphone, forms a wired or wireless connection to touch-capable display device 104.

At 304, the display of information on the touch-capable display device is controlled. For example, output module 112 of external display module 108 controls the display of information (e.g., representations 202, 204, and 206) on the touch-capable display device 104.

At 306, touch-input is received from the touch-capable display device via the wired or wireless connection. For example, input module 110 receives touch-input (e.g., when a user touches representations 202, 204, or 206).

At 308, the display of information on the touch-capable display device is modified based on the touch-input. For example, output module 112 modifies the display of information on the touch-capable display device 104 based on the touch-input.

FIG. 4 depicts a procedure 400 in an example implementation of controlling the display of information on an external touch-capable display device separately from the display of information on an integrated display.

At 402, a wired or wireless connection to a touch-capable display device is formed by a mobile computing device. For example, computing device 102, such as a smartphone, forms a wired or wireless connection to touch-capable display device 104.

At 404, the display of information on the touch-capable display device is controlled based on touch-input to the touch-capable display device and independent of input to the mobile computing device. For example, external display module 108 controls the display of information (e.g., representations 202, 204, and 206) on the touch-capable display device 104 and independent of input to the mobile computing device 102.

At 406, the display of information on an integrated display of the mobile computing device is controlled based on input to the mobile computing device and independent of the touch-input to the touch-capable display device. For example, external display module 201 controls the display of information (e.g., representations 208 and 212) on integrated display 106 of mobile computing device 102 and independent of the touch-input to the touch-capable display device 104. As discussed throughout, the external display module 108 may be implemented as a software stack that is independent of a second software stack that is implemented by the integrated display module 201.

### Example System and Device

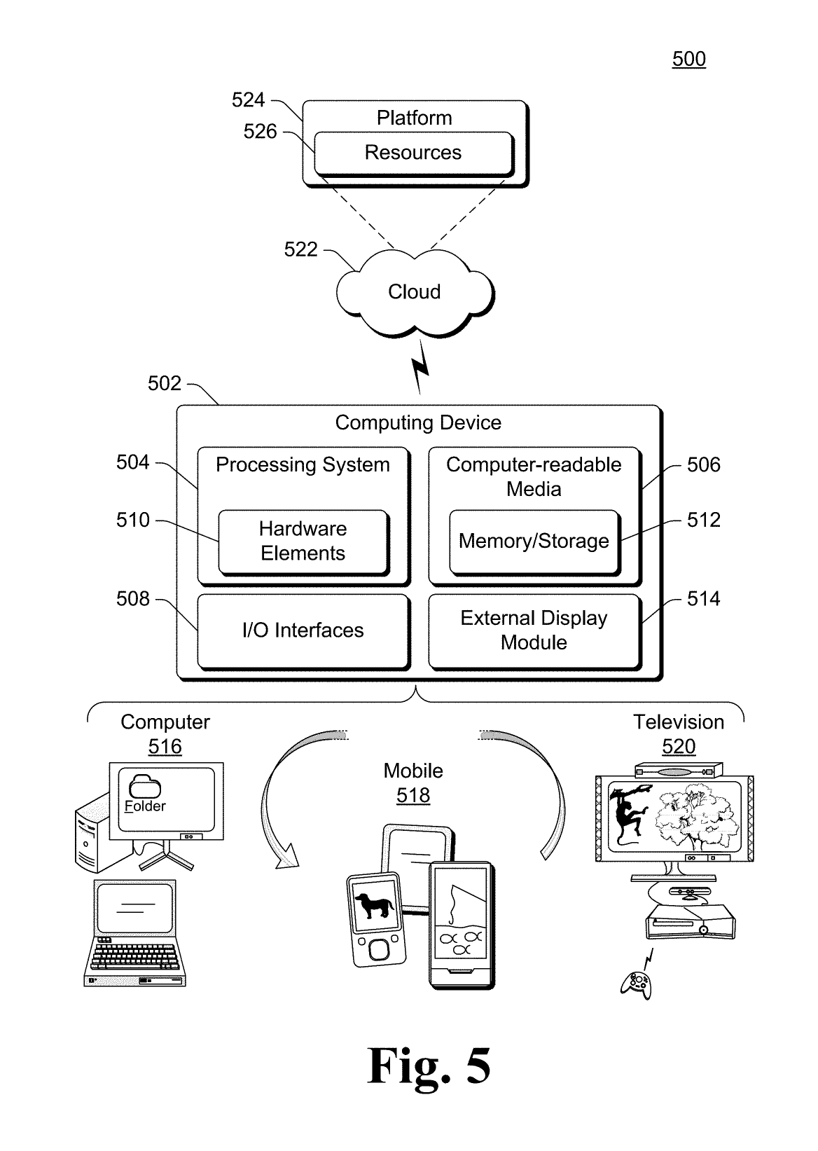

FIG. 5 illustrates an example system generally at 500 that includes an example computing device 502 that is representative of one or more systems and/or devices that may implement the various techniques described herein. The computing device 502 may be, for example, a server of a service provider, a device associated with a client (e.g., a client device), an on-chip system, and/or any other suitable computing device or computing system.

The example computing device 502 as illustrated includes a processing system 504, one or more computer-readable media 506, and one or more I/O Interfaces 508 that are communicatively coupled, one to another. Although not shown, the computing device 502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 504 is representative of functionality to perform one or more operations using hardware. Accordingly, the processing system 504 is illustrated as including hardware elements 510 that may be configured as processors, functional blocks, and so forth. This may include implementation in hardware as an application specific integrated circuit or other logic device formed using one or more semiconductors. The hardware elements 510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 506 is illustrated as including memory/storage 512. The memory/storage 512 represents memory/storage capacity associated with one or more computer-readable media. The memory/storage 512 may include volatile media (such as random access memory (RAM)) and/or nonvolatile media (such as read only memory (ROM), Flash memory, optical disks, magnetic disks, and so forth). The memory/storage 512 may include fixed media (e.g., RAM, ROM, a fixed hard drive, and so on) as well as removable media (e.g., Flash memory, a removable hard drive, an optical disc, and so forth). The computer-readable media 506 may be configured in a variety of other ways as further described below.

The one or more input/output interface(s) 508 are representative of functionality to allow a user to enter commands and information to computing device 502, and also allow information to be presented to the user and/or other components or devices using various input/output devices. Examples of input devices include a keyboard, a cursor control device (e.g., a mouse), a microphone (e.g., for voice inputs), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 502 may be configured in a variety of ways as further described below to support user interaction.

The computing device 502 also includes an external display module 514. The external display module 514 provides various functionality supporting touch-input for an external touch-capable display device as discussed above. The external display module 514 can implement, for example, the external display module 108 of FIG. 1.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of computing platforms having a variety of processors.

An implementation of the described modules and techniques may be stored on or transmitted across some form of computer-readable media. The computer-readable media may include a variety of media that may be accessed by the computing device 502. By way of example, and not limitation, computer-readable media may include “computer-readable storage media” and “computer-readable signal media.”

“Computer-readable storage media” refers to media and/or devices that enable persistent storage of information and/or storage that is tangible, in contrast to mere signal transmission, carrier waves, or signals per se. Thus, computer-readable storage media refers to non-signal bearing media. The computer-readable storage media includes hardware such as volatile and nonvolatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 502, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, the hardware elements 510 and computer-readable media 506 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 510. The computing device 502 may be configured to implement particular instructions and/or functions corresponding to the software and/or hardware modules. Accordingly, implementation of modules as a module that is executable by the computing device 502 as software may be achieved at least partially in hardware, e.g., through use of computer-readable storage media and/or hardware elements 510 of the processing system. The instructions and/or functions may be executable/operable by one or more articles of manufacture (for example, one or more computing devices 502 and/or processing systems 504) to implement techniques, modules, and examples described herein.

As further illustrated in FIG. 5, the example system 500 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 500, multiple devices are interconnected through a central computing device. The central computing device may be local to the multiple devices or may be located remotely from the multiple devices. In one or more embodiments, the central computing device may be a cloud of one or more server computers that are connected to the multiple devices through a network, the Internet, or other data communication link.

In one or more embodiments, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one or more embodiments, a class of target devices is created and experiences are tailored to the generic class of devices. A class of devices may be defined by physical features, types of usage, or other common characteristics of the devices.

In various implementations, the computing device 502 may assume a variety of different configurations, such as for computer 516, mobile 518, and television 520 uses. Each of these configurations includes devices that may have generally different constructs and capabilities, and thus the computing device 502 may be configured according to one or more of the different device classes. For instance, the computing device 502 may be implemented as the computer 516 class of a device that includes a personal computer, desktop computer, a multi-screen computer, laptop computer, netbook, and so on.

The computing device 502 may also be implemented as the mobile 518 class of device that includes mobile devices, such as a mobile phone, portable music player, portable gaming device, a tablet computer, a multi-screen computer, and so on. The computing device 502 may also be implemented as the television 520 class of device that includes devices having or connected to generally larger screens in casual viewing environments. These devices include televisions, set-top boxes, gaming consoles, and so on.

The techniques described herein may be supported by these various configurations of the computing device 502 and are not limited to the specific examples of the techniques described herein. This functionality may also be implemented all or in part through use of a distributed system, such as over a “cloud” 522 via a platform 524 as described below.

The cloud 522 includes and/or is representative of a platform 524 for resources 526. The platform 524 abstracts underlying functionality of hardware (e.g., servers) and software resources of the cloud 522. The resources 526 may include applications and/or data that can be utilized while computer processing is executed on servers that are remote from the computing device 502. Resources 526 can also include services provided over the Internet and/or through a subscriber network, such as a cellular or Wi-Fi network.

The platform 524 may abstract resources and functions to connect the computing device 502 with other computing devices. The platform 524 may also serve to abstract scaling of resources to provide a corresponding level of scale to encountered demand for the resources 526 that are implemented via the platform 524. Accordingly, in an interconnected device embodiment, implementation of functionality described herein may be distributed throughout the system 500. For example, the functionality may be implemented in part on the computing device 502 as well as via the platform 524 that abstracts the functionality of the cloud 522.

### Conclusion and Example Implementations

Example implementations described herein include, but are not limited to, one or any combinations of one or more of the following examples:

A mobile computing device comprising: a network interface configured to form a wired or wireless connection to a touch-capable display device; and an external display module implemented at least partially in hardware, the external display module configured to: control the display of information on the touch-capable display device; receive, via the wired or wireless connection, touch-input from the touch-capable display device; and modify the display of information on the touch-capable display device based on the touch-input.

A mobile computing device as described above, wherein the mobile computing device comprises a smartphone.

A mobile computing device as described above, wherein the mobile computing device further comprises an integrated display.

A mobile computing device as described above, wherein the external display module is further configured to cause display of different information on the integrated display of the mobile computing device concurrently with the display of information on the touch-capable display device.

A mobile computing device as described above, wherein the external display module is configured to modify the display of information on the touch-capable display device without modifying the display of the different information on the integrated display.

A mobile computing device as described above, wherein the external display module is further configured to: receive input to the integrated display; and modify the display of the different information on the integrated display without modifying the display of information on the touch-capable display device.

A mobile computing device as described above, wherein the external display module is further configured to determine that the touch-capable display device is configured to receive touch-input based on detection of a digitizer of the touch-capable display device.

A mobile computing device as described above, wherein the external display module is configured to display information on the touch-capable display device by causing display of an on-screen keyboard.

A mobile computing device as described above, wherein the external display module is configured to: cause display of information that includes an on-screen keyboard on the touch-capable display device if a hardware keyboard is coupled to the touch-capable display device; or cause display of information that does not include the on-screen keyboard if the hardware keyboard is coupled to the touch-capable display device.

A method implemented in a smartphone, the method comprising: forming a wired or wireless connection to a touch-capable display device; controlling the display of information on the touch-capable display device; receiving, via the wired or wireless connection, touch-input from the touch-capable display device; and modifying the display of information on the touch-capable display device based on the touch-input.

A method as described above, further comprising displaying different information on an integrated display of the smartphone concurrently with the display of information on the touch-capable display device.

A method as described above, wherein the modifying further comprises modifying the display of information on the touch-capable display device without modifying the display of the different information on the integrated display.

A method as described above, further comprising receiving input to the integrated display, and modifying the display of the different information on the integrated display without modifying the display of information on the touch-capable display device.

A method as described above, further comprising determining that the touch-capable display device is configured to receive touch-input based on detection of a digitizer of the touch-capable display device.

A method as described above, wherein the displaying information on the touch-capable display device includes display of an on-screen keyboard.

A method as described above, wherein the information displayed on the touch-capable device includes an on-screen keyboard if a hardware keyboard is coupled to the touch-capable display device, and wherein the information displayed on the touch-capable device does not include the on-screen keyboard if the hardware keyboard is coupled to the touch-capable display device.

A smartphone comprising: an integrated display; a network interface for establishing a connection to a touch-capable display device; at least a memory and a processor to implement an external display module and an integrated display module; the external display module configured to control the display of information on the touch-capable display device; and the integrated display module configured to control the display of information on the integrated display of the smartphone.

A smartphone as described above, wherein the external display module is implemented as a software stack that is independent of an additional software stack that is implemented by the integrated display module.

A smartphone as described above, wherein the external display module is configured to control the display of information on the touch-capable display device based on touch-input to the touch-capable display device and independent of input to the smartphone.

A smartphone as described above, wherein the integrated display module is configured to control the display of information on the integrated display based on input to the smartphone and independent of the touch-input to the touch-capable display device.

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. A mobile computing device comprising:
a network interface configured to form a wired or wireless connection to a touch-capable display device; and
an external display module implemented at least partially in hardware, the external display module configured to:
control the display of information on the touch-capable display device;
receive, via the wired or wireless connection, touch-input from the touch-capable display device; and
modify the display of information on the touch-capable display device based on the touch-input.

2. The mobile computing device of claim 1, wherein the mobile computing device comprises a smartphone.

3. The mobile computing device of claim 1, wherein the mobile computing device further comprises an integrated display.

4. The mobile computing device of claim 3, wherein the external display module is further configured to cause display of different information on the integrated display of the mobile computing device concurrently with the display of information on the touch-capable display device.

5. The mobile computing device of claim 4, wherein the external display module is configured to modify the display of information on the touch-capable display device without modifying the display of the different information on the integrated display.

6. The mobile computing device of claim 4, wherein the external display module is further configured to:
receive input to the integrated display; and
modify the display of the different information on the integrated display without modifying the display of information on the touch-capable display device.

7. The mobile computing device of claim 1, wherein the external display module is further configured to determine that the touch-capable display device is configured to receive touch-input based on detection of a digitizer of the touch-capable display device.

8. The mobile computing device of claim 1, wherein the external display module is configured to display information on the touch-capable display device by causing display of an on-screen keyboard.

9. The mobile computing device of claim 1, wherein the external display module is configured to:
cause display of information that includes an on-screen keyboard on the touch-capable display device if a hardware keyboard is coupled to the touch-capable display device; or
cause display of information that does not include the on-screen keyboard if the hardware keyboard is coupled to the touch-capable display device.

10. A method implemented in a smartphone, the method comprising:
forming a wired or wireless connection to a touch-capable display device;
controlling the display of information on the touch-capable display device;
receiving, via the wired or wireless connection, touch-input from the touch-capable display device; and
modifying the display of information on the touch-capable display device based on the touch-input.

11. The method of claim 10, further comprising displaying different information on an integrated display of the smartphone concurrently with the display of information on the touch-capable display device.

12. The method of claim 11, wherein the modifying further comprises modifying the display of information on the touch-capable display device without modifying the display of the different information on the integrated display.

13. The method of claim 11, further comprising receiving input to the integrated display, and modifying the display of the different information on the integrated display without modifying the display of information on the touch-capable display device.

14. The method of claim 10, further comprising determining that the touch-capable display device is configured to receive touch-input based on detection of a digitizer of the touch-capable display device.

15. The method of claim 10, wherein the displaying information on the touch-capable display device includes display of an on-screen keyboard.

16. The method of claim 10, wherein the information displayed on the touch-capable device includes an on-screen keyboard if a hardware keyboard is coupled to the touch-capable display device, and wherein the information displayed on the touch-capable device does not include the on-screen keyboard if the hardware keyboard is coupled to the touch-capable display device.

17. A smartphone comprising:
an integrated display;
a network interface for establishing a connection to a touch-capable display device;
at least a memory and a processor to implement an external display module and an integrated display module;
the external display module configured to control the display of information on the touch-capable display device; and
the integrated display module configured to control the display of information on the integrated display of the smartphone.

18. The smartphone of claim 17, wherein the external display module is implemented as a software stack that is independent of an additional software stack that is implemented by the integrated display module.

19. The smartphone of claim 17, wherein the external display module is configured to control the display of information on the touch-capable display device based on touch-input to the touch-capable display device and independent of input to the smartphone.

20. The smartphone of claim 17, wherein the integrated display module is configured to control the display of information on the integrated display based on input to the smartphone and independent of the touch-input to the touch-capable display device.
